(19) United States
(12) Patent Application Publication
(10) Pub. No.: US 2014/0379162 A1
(43) Pub. Date: Dec. 25, 2014

(54) SERVER SYSTEM AND MONITORING METHOD

(71) Applicant: Inventec (Pudong) Technology Corporation, Shanghai (CN)

(72) Inventor: Peng HU, Shanghai (CN)

(73) Assignee: Inventec (Pudong) Technology Corporation, Shanghai (CN)

(21) Appl. No.: 14/035,910

(22) Filed: Sep. 24, 2013

(30) Foreign Application Priority Data
Jun. 25, 2013 (CN) 201310257359.2

(51) Int. Cl. G05B 15/02

(52) U.S. Cl. CPC G05B 15/02
USPC 700/299

(57) ABSTRACT

A server system including a processing unit, a basic input/output system (BIOS) and a control unit, and a monitoring method are provided. The BIOS communicating with the processing unit, detects a model of the processing unit, and according to the model, outputs a temperature threshold for the processing unit. The control unit coupled to the processing unit and communicating with the BIOS, receives the temperature threshold, monitors a current temperature of the processing unit and compares the current temperature with the temperature threshold to obtain a comparison result, and according to the comparison result, outputs a warning signal. When the comparison result indicates that the current temperature is higher than the temperature threshold, the control unit outputs the warning signal.

### CROSS-REFERENCE TO RELATED APPLICATIONS

This non-provisional application claims priority under 35 U.S.C. §119(a) on Patent Application No(s). 201310257359.2 filed in China on Jun. 25, 2013, the entire contents of which are hereby incorporated by reference.

### BACKGROUND OF THE INVENTION

1. Technical Field of the Invention

The disclosure relates to a server system and a monitoring method, more particularly to a server system and a monitoring method capable of enhancing the monitoring ability to monitor the temperature of a central processing unit (CPU) in a server and reducing the manufacture costs of server.

2. Description of the Related Art

With the enhancement of electronic technology, electronic computing devices become more important and are required much more in various applications recently. For instant, the information technology field requires the better performance and usability of a network server system to support the development of network and support the widely usage of small and medium-sized local area networks (LAN) in a company. Moreover, data servers in the network server system are required to work as platforms to store and read data for the requirement of statistic analysis. That is why the demand for data servers increases much more, and is why a stable and efficient server is very important.

In order to keep the server off malfunctions, the firmware to a baseboard management controller (BMC) is designed to monitor the temperature of central processing unit (CPU) in the server. When the temperature of CPU rises to a threshold, the BMC will output a temperature warning and correspondingly adjust a rotation speed of fan. Therefore, whenever the model of CPU is changed, the version of firmware to the BMC shall also be renewed, whereby the BMC can proceed to monitor the temperature of CPU in real time. However, sometimes the version of firmware to the BMC may not be updated in real time, so the BMC may perform wrong actions such as outputting a wrong temperature warning and not outputting a temperature warning. On the other hand, if many versions of firmware to the BMC are predeterminedly installed to deal with various CPU standards, this will increase the manufacture costs of server.

### SUMMARY OF THE INVENTION

A monitoring method according to an embodiment of the disclosure is applicable to a server system and includes the following steps. When the server system starts a power on self test (POST), a model of a processing unit is detected by a BIOS. A temperature threshold to the processing unit is acquired by the BIOS according to the model. The temperature threshold is outputted from the BIOS to a control unit. A current temperature of the processing unit is monitored and is compared with the temperature threshold to obtain a comparison result by the control unit. When the comparison result indicates that the current temperature is higher than the temperature threshold, a warning signal is outputted by the control unit.

A server system according to an embodiment of the disclosure includes a processing unit, a BIOS and a control unit. The BIOS coupled to the processing unit and is used for detecting a model of the processing unit and outputting a temperature threshold associated with the processing unit. The control unit coupled to the processing unit and the BIOS is configured to receive the temperature threshold, monitor a current temperature of the processing unit, compare the current temperature with the temperature threshold to obtain a comparison result, and according to the comparison result, output a warning signal. When the comparison result indicates that the current temperature is higher than the temperature threshold, the control unit outputs the warning signal.

### BRIEF DESCRIPTION OF THE DRAWINGS

The present disclosure will become more fully understood from the detailed description given herein below for illustration only and thus does not limit the present disclosure, wherein:

FIG. 1 is a schematic diagram of a server system of the disclosure; and

FIG. 2 is a flowchart of a monitoring method of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

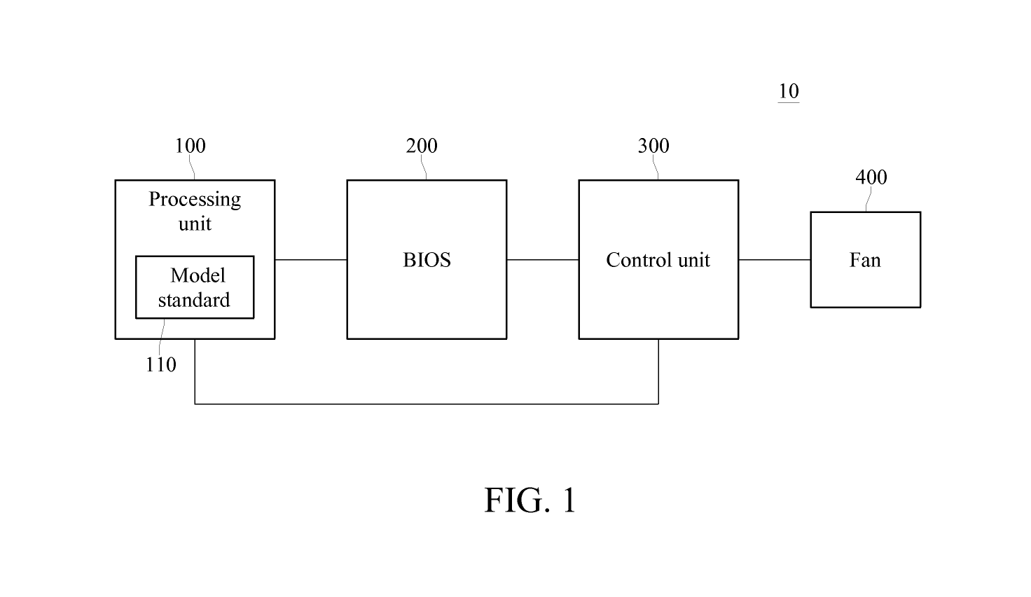

FIG. 1 is a schematic diagram of a server system of the disclosure. A server system 10 is applicable to enhance the monitoring ability of the control unit 300 to monitor the temperature of the processing unit 100. The server system 10 includes a processing unit 100, a basic input/output system (BIOS) 200 and a control unit 300.

The processing unit 100 has a model 110. For example, the processing unit 100 is a central processing unit (CPU) or one similar component. The BIOS 200 communicates with the processing unit 100 to detect the model 110 of the processing unit 100 and output a temperature threshold of the processing unit 100 according to the model 110.

The control unit 300 is coupled to the processing unit 100 and the BIOS 200. Specifically, the BIOS 200 communicates with the control unit 300 through an intelligent platform management interface (IPMI). The control unit 300 receives the temperature threshold, monitors a current temperature of the processing unit 100, and compares the current temperature with the temperature threshold to obtain a comparison result. In this way, the control unit 300 outputs a warning signal according to the comparison result. Specifically, when the comparison result indicates that the current temperature is higher than the temperature threshold, the control unit outputs the warning signal. On the other hand, the control unit 300 also outputs a driving signal according to the current temperature. For example, the control unit 300 is a baseboard management controller (BMC) or one similar component. The control unit 300 includes a sensor data record (SDR) having the temperature threshold.

Besides, the server system 10 further includes a fan 400. The fan 400 is coupled to the control unit 300 and receives the driving signal outputted by the control unit 300, to rotate at a rotation speed. More particularly, the rotation speed can be adjusted according to the driving signal outputted by the control unit 300. When the fan 400 rotates at the rotation speed, the heat caused by the processing unit 100 can be dissipated.

In this and some embodiments, whether the model 110 of the processing unit 100 satisfies a default model is determined by the BIOS 200. When the model 110 satisfies the default model, the BIOS 200, according to an algorithm, directly acquires the temperature threshold corresponding to the default model from a register of the processing unit 100 and outputs the temperature threshold to the control unit 300. Specifically, the BIOS 200 firstly acquires a maximum central temperature value that the processing unit 100 can support, from the register, and then calculates and obtains the temperature threshold corresponding to the default model according to the maximum central temperature value and the algorithm which is expressed as follows:

Upper non-critical threshold=Maximum central temperature value −5;

Upper Critical threshold=Maximum central temperature value; and

Upper non-recoverable threshold=Maximum central temperature value +5.

Then, the control unit 300 compares the current temperature of the processing unit 100 with the temperature threshold to obtain a comparison result. When the comparison result indicates that the current temperature of the processing unit 100 is not higher than the temperature threshold, the control unit 300 will not output a warning signal. When the comparison result indicates that the current temperature of the processing unit 100 is higher than or equal to the temperature threshold, the control unit 300 will output the warning signal according to the comparison result. Then, the control unit 300 outputs a corresponding driving signal to the fan 400 according to the current temperature to drive the fan 400 to dissipate the heat caused by the processing unit 100.

In contrast, when the model 110 does not satisfy the default model, the BIOS 200 looks up the temperature threshold in a default table and then outputs the temperature threshold to the control unit 300. The control unit 300 further compares the current temperature of the processing unit 100 with the temperature threshold to obtain a comparison result. When the comparison result indicates that the current temperature of the processing unit 100 is not higher than the temperature threshold, the control unit 300 will not output a warning signal. When the current temperature of the processing unit 100 is higher than or equal to the temperature threshold, the control unit 300 will output a warning signal according to the comparison result. Moreover, the control unit 300 also outputs a driving signal to the fan 400 according to the current temperature, to drive the fan 400 to dissipate the heat caused by the processing unit 100. Therefore, the server system 10 in the disclosure can enhance the monitoring ability of the control unit 300 to monitor the temperature of the processing unit 100 through the BIOS 200.

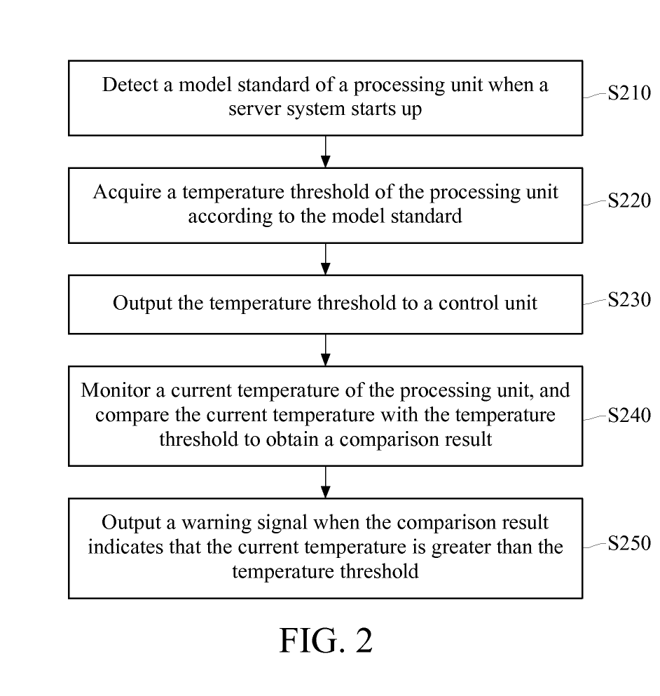

Accordingly, the aforementioned operation of server system is concluded in a monitoring method as shown in FIG. 2 which is a flowchart of a monitoring method of the disclosure. When the server system starts a POST, a BIOS detects a model of a processing unit (step S210). The BIOS according to the model acquires a temperature threshold of the processing unit (step S220). The BIOS outputs the temperature threshold to a control unit (step S230). The control unit monitors a current temperature of the processing unit and compares the current temperature with the temperature threshold to obtain a comparison result (step S240). When the comparison result indicates that the current temperature is higher than the temperature threshold, the control unit will output a warning signal (step S250). Moreover, the control unit according to the current temperature outputs a driving signal to control a fan to rotate at a rotation speed.

Moreover, the BIOS determines the source of a temperature threshold, depending on whether the model satisfies a default model or not. When the model satisfies the default model, the BIOS according to the above algorithm obtains the temperature threshold corresponding to the default value and then outputs the temperature threshold to the control unit. When the model does not satisfy the default model, the BIOS according to the model looks up the temperature threshold in the default table and then outputs the temperature threshold to the control unit.

As set forth above, the server system and the monitoring method in the disclosure detect a model of the processing unit by the BIOS, acquire and output a temperature threshold associated with the control unit according to the model, compare a current temperature of the processing unit with the temperature threshold to obtain a comparison result by the control unit, and eventually output a warning signal according to the comparison result by the control unit. In this way, the disclosure may efficiently reduce the manufacture costs of server and enhance the monitoring ability of the control unit to monitor the temperature of the processing unit in the server.

What is claimed is:

1. A monitoring method applicable to a server system and comprising:
detecting a model of a processing unit by a basic input/output system (BIOS) when the server system starts a power on self test (POST);
acquiring a temperature threshold of the processing unit according to the model by the BIOS;
outputting the temperature threshold from the BIOS to a control unit;
monitoring a current temperature of the processing unit and comparing the current temperature of the processing unit with the temperature threshold to obtain a comparison result by the control unit; and
outputting a warning signal by the control unit when the comparison result indicates that the current temperature is higher than the temperature threshold.

2. The monitoring method according to claim 1, wherein when the processing unit satisfies a default model, the temperature threshold corresponding to the default model is obtained from a register of the processing unit according to an algorithm and then is outputted to the control unit, and when the processing unit does not satisfy the default model, the temperature threshold is looked up and acquired in a default table and is outputted to the control unit.

3. The monitoring method according to claim 1, further comprising outputting a driving signal according to the current temperature to control a rotation speed of a fan by the control unit.

4. The monitoring method according to claim 1, wherein the processing unit is a central processing unit (CPU).

5. The monitoring method according to claim 1, wherein the control unit is a baseboard management controller (BMC).

6. A server system, comprising:
a processing unit;
a BIOS communicating with the processing unit, and used for detecting a model of the processing unit , and outputting a temperature threshold associated with the processing unit according to the model; and
a control unit coupled to the processing unit and the BIOS, and configured to receive the temperature threshold, and monitor a current temperature of the processing unit, compare the current temperature of the processing unit with the temperature threshold to obtain a comparison result, and output a warning signal according to the comparison result;
wherein when the comparison result indicates that the current temperature is higher than the temperature threshold, the control unit outputs the warning signal.

7. The server system according to claim 6, wherein when the processing unit satisfies a default model, the BIOS obtains the temperature threshold corresponding to the default model, from a register of the processing unit according to an algorithm and then outputs the temperature threshold to the control unit, and when the processing unit does not satisfy the default model, the BIOS looks up the temperature threshold in a default table and then outputs the temperature threshold to the control unit.

8. The server system according to claim 6, further comprising:
a fan coupled to the control unit and configured to receive a driving signal outputted by the control unit and according to the driving signal, rotate at a rotation speed, wherein the control unit outputs the driving signal according to the current temperature.

9. The server system according to claim 6, wherein the processing unit is a CPU, and the control unit is a BMC.

10. The server system according to claim 6, wherein the control unit comprises a sensor data record having the temperature threshold.
